(19) United States
(12) Patent Application Publication
(10) Pub. No.: US 2016/0019687 A1
(43) Pub. Date: Jan. 21, 2016

(54) IMAGE MEASURING APPARATUS

(71) Applicant: MITUTOYO CORPORATION, Kanagawa (JP)

(72) Inventors: Gyokubu CHO, Kanagawa (JP); Akira TAKADA, Yokohama (JP); Takashi HANAMURA, Kanagawa (JP); Takuho MAEDA, Kanagawa (JP)

(73) Assignee: MITUTOYO CORPORATION, Kanagawa (JP)

(21) Appl. No.: 14/797,613

(22) Filed: Jul. 13, 2015

(30) Foreign Application Priority Data
Jul. 18, 2014 (JP) 2014-148285

(51) Int. Cl. G06T 7/00; G01B 11/00; G02B 21/36; H04N 5/232

(52) U.S. Cl. CPC G06T 7/004; H04N 5/23293; G01B 11/00; G02B 21/365

(57) ABSTRACT

An image measuring apparatus is configured such that an image of a measured object placed on a stage is captured by a camera, the captured image is displayed on a captured image display screen, and determination results based on results of a measurement are displayed in an overview list separately from the captured image of the measured object. The image measuring apparatus includes a selector selecting measurement results that include determination results on the list; and an emphasis displayer providing an emphasis display on the captured image display screen for a measurement position corresponding to the selected measurement results.

### CROSS-REFERENCE TO RELATED APPLICATIONS

The present application claims priority under 35 U.S.C. §119 of Japanese Application No. 2014-148285, filed on Jul. 18, 2014, the disclosure of which is expressly incorporated by reference herein in its entirety.

### BACKGROUND OF THE INVENTION

1. Field of the Invention

The present disclosure relates to an image measuring apparatus, and in particular to an image measuring apparatus favorably used in an image measuring device, a quantitative microscope having an installed imaging unit, or the like. The image measuring apparatus is configured such that an image of a measured object placed on a stage is captured by a camera, the captured image is displayed on a captured image display screen, and determination results based on results of a measurement are displayed in an overview list separately from the captured image of the measured object.

2. Description of Related Art

A typical image measuring device, such as those described in Japanese Patent Publication No. H03-57403 and Japanese Patent Laid-open Publication No. 2003-139520, includes a parts program capable of recording a measurement procedure that has been performed once and, when measuring a measured object (also referred to as a work piece) having an identical shape, is capable of automatically recreating the recorded measurement procedure. In addition, as described in Japanese Patent Laid-open Publication No. 2001-319219, the image measuring apparatus includes tolerance comparison in which, after a measured object has been measured, measured values are compared against design values to determine whether the measured values are within a predetermined tolerance. Typically, in a case where continuous measurement of a plurality of work pieces having identical shapes is performed by the image measuring device using the parts program, an operator executes the parts program for each work piece and verifies the output tolerance determination results to determine quality of the work piece.

Display of the determination results of the tolerance comparison (“OK” or “NG” (fail)) is performed by presenting notations for the measured values and design values in a measurement results display region, as shown in FIG. 1, for example. However, the tolerance determination results are difficult to grasp with this display and so, as described in Japanese Patent Laid-open Publication No. 2001-59708, an overview display is provided in which the determination results are given in a list, separately from an image of the measured object.

The determination results of the tolerance comparison are typically displayed together with the measurement results, as shown in FIG. 1. Therefore, in a case where measurement is conducted while changing a stage position, even when the determination results are outside the tolerances and return an “NG” immediately after measurement is performed or during measurement within one screen, or a failure occurs in measurement due to an inability to detect an edge, lack of a work piece, adhesion of debris, insufficient illumination level, and the like, a cause can be verified and measurement can be repeated.

However, in a case of measurement outside the screen, which requires displacing the stage, or in a case having a plurality of measurement positions, it is difficult to identify the measurement position where the NG or measurement failure occurred after measurement has ended and, in some cases, measurement must be repeated starting over from the beginning in order to identify the measurement position.

### SUMMARY OF THE INVENTION

The present disclosure has been conceived in order to resolve the conventional circumstances described above, and therefore is configured to identify and readily locate a measurement position even in a case where a determination result of NG is generated after measurement ends or a case where measurement fails, and improves operability in identifying a cause for an NG determination result and in remeasuring.

The present disclosure addresses the above circumstances with an image measuring apparatus configured such that an image of a measured object placed on a stage is captured by a camera, the captured image is displayed on a captured image display screen, and determination results based on results of a measurement are displayed in an overview list separately from the captured image of the measured object. The image measuring apparatus includes a selector selecting measurement results that include determination results on the list; and an emphasis displayer providing an emphasis display on the captured image display screen for a measurement position corresponding to the selected measurement results.

Herein, details of the measurement results can be displayed at the measurement position having the emphasis display.

In addition, measurement can be repeated while the details of the measurement results are displayed.

Furthermore, when the measurement position corresponding to the selected measurement results does not lie within the presently displayed captured image display screen, navigation information can be displayed to cause the measurement position to be displayed within the captured image display screen.

Alternatively, when the measurement position corresponding to the selected measurement results does not lie within the presently displayed captured image display screen, the stage and camera can be displaced relative to each other to cause the measurement position to be displayed within the captured image display screen.

According to the present disclosure, the measurement position can be identified and readily located even in a case where a determination result of NG is generated after measurement ends or a case where measurement fails. Accordingly, operability can be improved in identifying a cause for an NG determination result and in remeasuring, and operability of the image measuring apparatus can be improved. In addition, management costs for an operator can be reduced.

### BRIEF DESCRIPTION OF THE DRAWINGS

The present invention is further described in the detailed description which follows, in reference to the noted plurality of drawings by way of non-limiting examples of exemplary embodiments of the present invention, in which like reference numerals represent similar parts throughout the several views of the drawings, and wherein:

FIG. 1 illustrates a conventional display of tolerance determination results in an image measuring device;

FIG. 2 is a perspective view of an exemplary overall configuration of an image measuring device to which the present disclosure is applied;

FIG. 3 is a block diagram illustrating a configuration of a computer system in the image measuring device;

FIG. 4 is a flowchart illustrating a procedural flow according to a first embodiment of the present disclosure in the image measuring device;

FIG. 5 illustrates an exemplary display on a display screen in according to the first embodiment;

FIG. 6 illustrates a first modification of a display of overall determination results in the image measuring device;

FIG. 7 is a flowchart illustrating a procedural flow according to a second embodiment of the present disclosure;

FIG. 8 illustrates an exemplary display on a display screen according to the second embodiment;

FIG. 9 is a flowchart illustrating a procedural flow according to a third embodiment of the present disclosure;

FIG. 10 illustrates an exemplary display on a display screen according to the third embodiment;

FIGS. 11A and 11B illustrate a second modification of a display of overall determination results;

FIGS. 12A and 12B illustrate a third modification of a display of overall determination results; and

FIGS. 13A and 13B illustrate a fourth modification of a display of overall determination results.

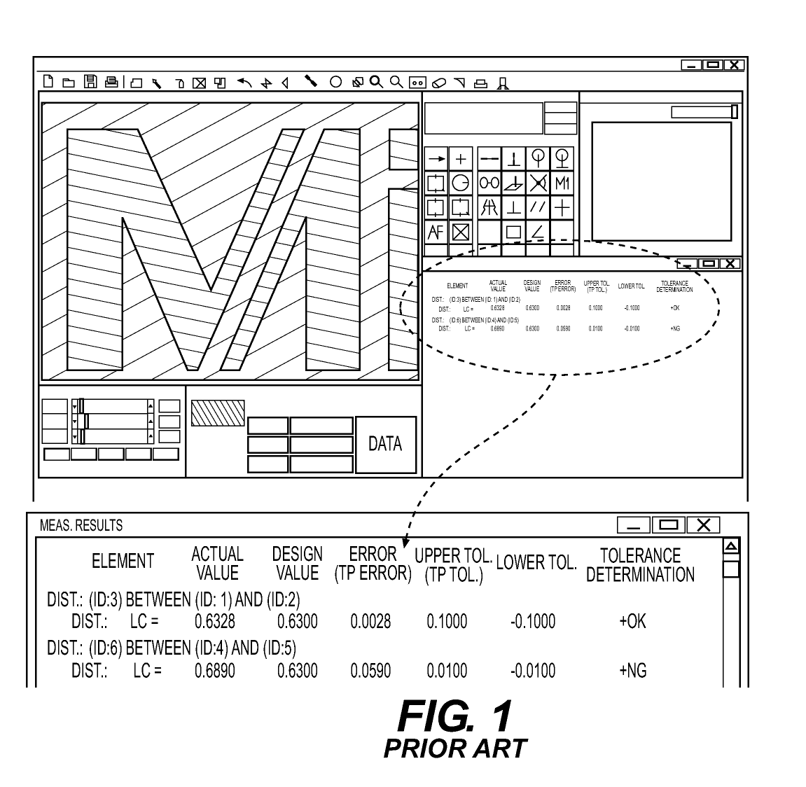

### DETAILED DESCRIPTION OF THE INVENTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the forms of the present invention may be embodied in practice.

Hereafter, embodiments of the present invention are described in detail with reference to the drawings. Moreover, the present invention is not limited by the content described in the embodiments and examples that follow. Configuration requirements in the following embodiments and examples may also include that which is readily conceivable by one skilled in the art, that which is substantially similar, and that which encompasses an equivalent scope. Furthermore, the configuration requirements disclosed in the following embodiments and examples may be combined as appropriate, or may be selectively employed as appropriate.

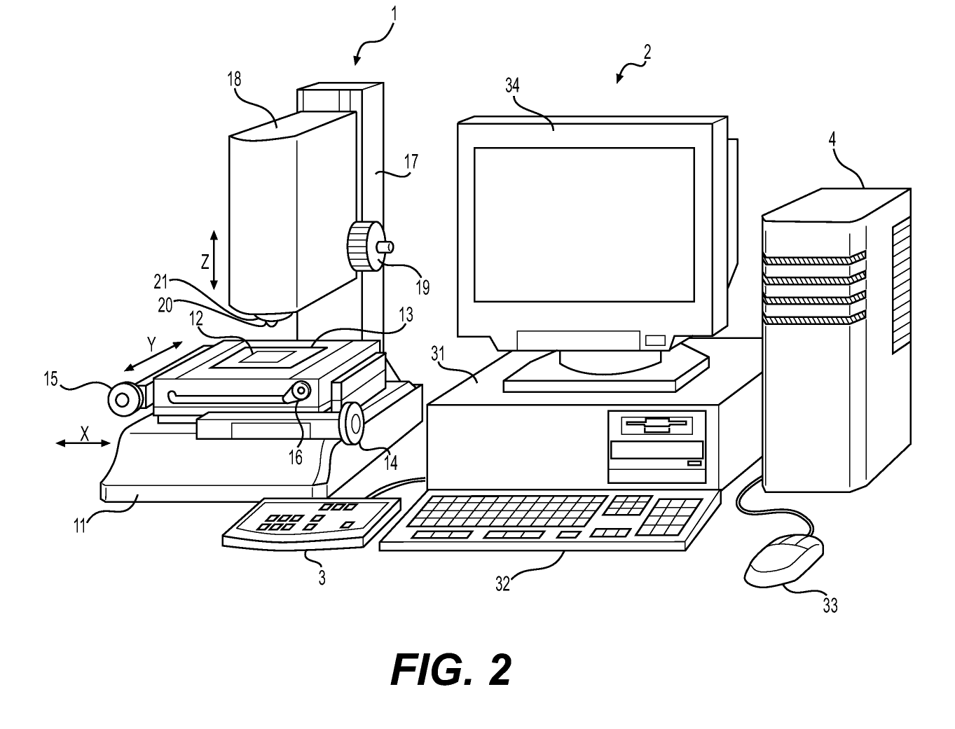

FIG. 2 illustrates an overall configuration of a manually operated image measuring device to which the present disclosure is applied. The image measuring device is configured by a measuring device main body 1 of a non-contact image measuring type; a computer system 2 executing a process assisting in a stage displacement operation of the measuring device main body 1, and executing required measurement data processing; a command inputter 3 giving a necessary measurement command and measurement parameters to the measuring device main body 1; a keyboard 32; a mouse 33; and a power station 4 supplying stable electric power to the various components.

The measuring device main body 1 includes a table 11 and a stage 13 mounted above the table 11. A work piece 12 (measured object) may be placed on the stage 13. An X axis drive shaft 14 and a Y axis drive shaft 15 drive the stage 13 in an X axis direction and a Y axis direction, respectively. An upwardly-extending frame 17 is fixated to a back end portion of the table 11. A camera unit 18 is supported on the frame 17. The camera unit 18 is capable of being displaced by a Z axis drive shaft 19 in a Z axis direction along a guide rail formed on the frame 17. A camera (for example, a CCD camera) 20 is mounted in an interior of the camera unit 18 so as to capture an image of the stage 13 from above. A ring-shaped illumination device 21 illuminating the work piece 12 is provided proximate to a bottom end of the camera 20.

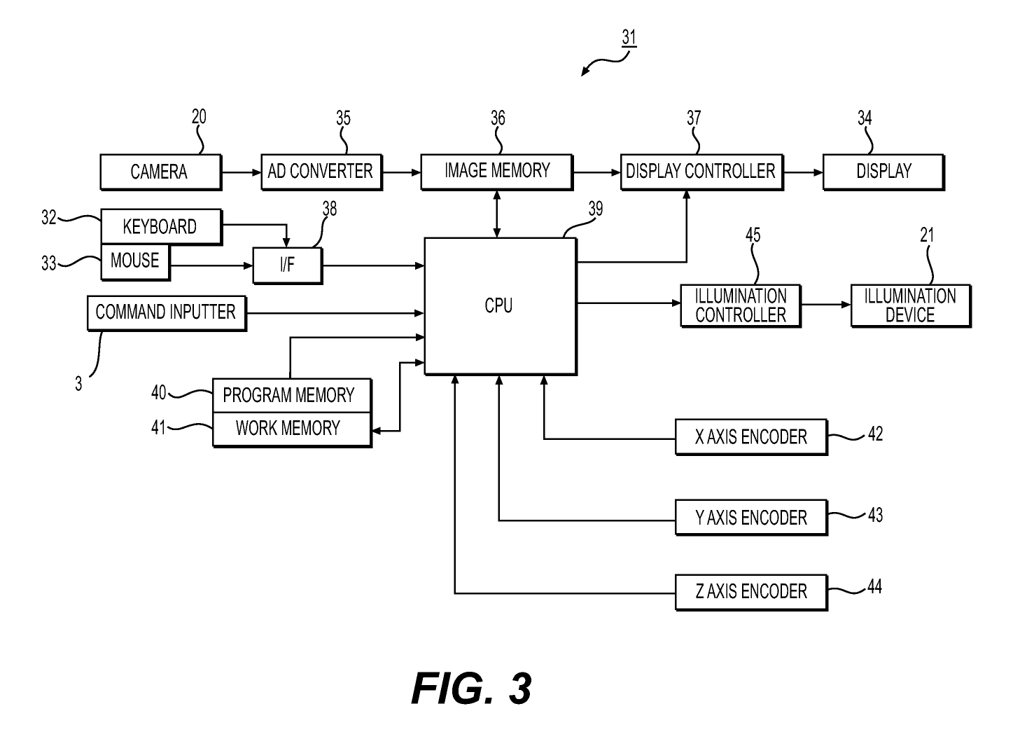

The computer system 2 is configured to include a computer main body 31, the keyboard 32, the mouse 33, and a display screen (for example, a liquid crystal display screen or a CRT display screen) 34. This system, which is based around the computer main body 31, may be configured as shown in FIG. 3, for example. An image signal for an image of the work piece 12 captured by the camera 20 is converted into digital image data by an AD converter 35 and is stored in an image memory 36. The digital image data stored in the image memory 36 is displayed on the display screen 34 due to operations by a display controller 37. An operator's command input using the keyboard 32 and mouse 33 is transmitted to a CPU 39 via an interface (I/F) 38. The CPU 39 executes a measurement process according to the operator's command or a parts program stored in a program memory 40. A working memory 41 provides a work space for various processes of the CPU 39.

In order to detect each of the X, Y, and Z axis direction positions of the camera 20 relative to the stage 13, an X axis encoder 42, a Y axis encoder 43, and a Z axis encoder 44 are also provided. Output from these encoders 42 to 44 is taken into the CPU 39. Based on a command value generated by the CPU 39, an illumination controller 45 generates an analog quantity command voltage and drives the illumination device 21.

Hereafter, various embodiments of the present disclosure are described in detail.

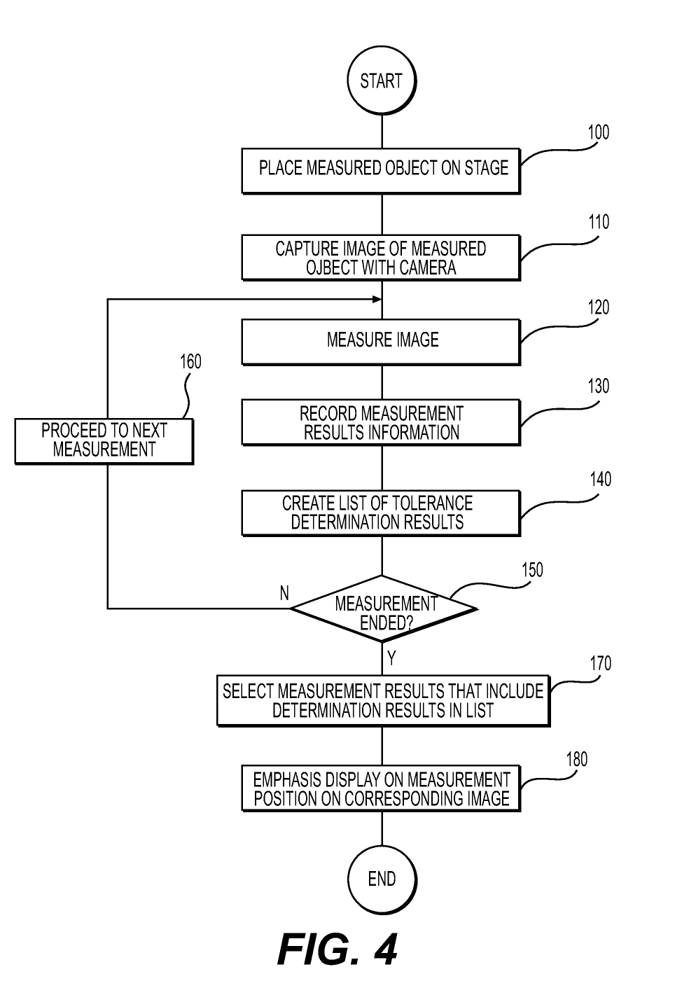

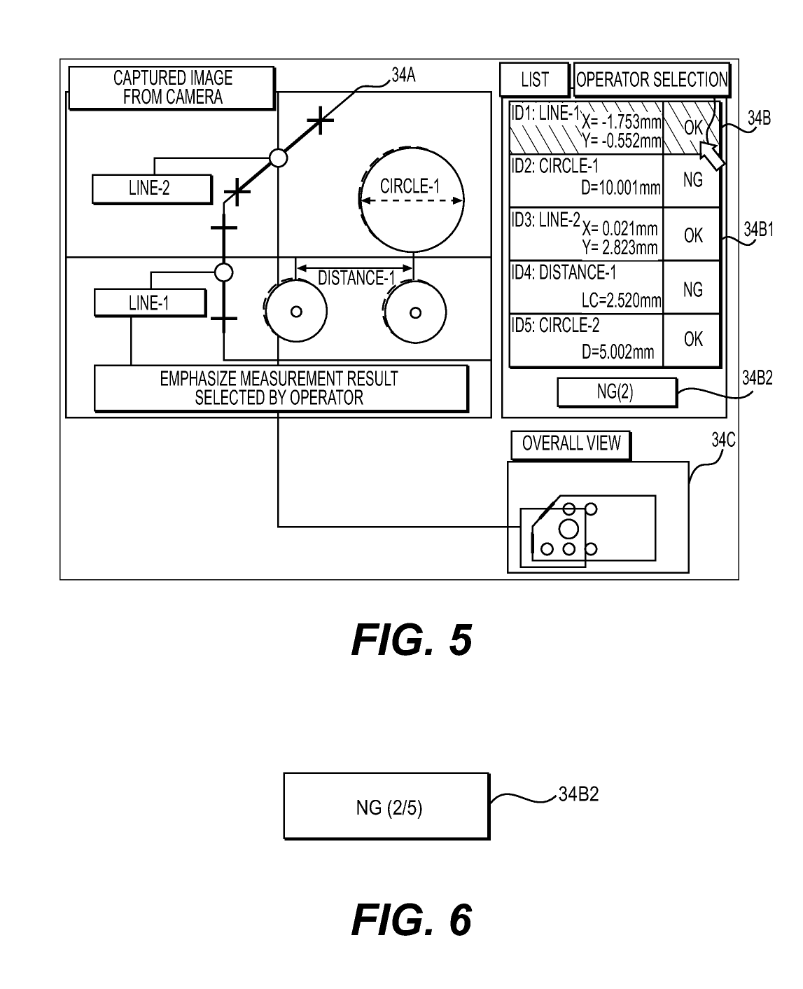

FIG. 4 illustrates a procedural flow, while FIG. 5 illustrates an exemplary display on the display screen 34 according to a first embodiment of the present disclosure. In the first embodiment, when a determination result is selected from a list, an emphasis display is provided to a corresponding measurement position on a captured image display screen.

In the first embodiment, first, in step 100, a measured object (work piece 12) is placed on the stage 13 of the measuring device main body 1.

Next, in step 110, an image of the work piece 12 is captured by the camera 20 mounted to the measuring device main body 1.

Next, in step 120, a desired element and edge detection tool is selected on a captured image display screen 34A displaying the captured image (enlarged image of the work piece 12) from the camera 20, shown on a top left side of FIG. 5, and measurement is performed.

Information for measurement results including tolerance determination results is recorded each time measurement is performed (step 130), and a tolerance determination results list 34B is created that an operator can understand at any time (step 140).

Until a determination is made in step 150 that measurement has ended, the process advances to the next measurement position in step 160 and repeats steps 120 through 140.

The tolerance determination results can be displayed with different colors, such as OK being green and fail (NG) being red.

After a determination is made in step 150 that measurement has ended, when an operator selects in step 170 measurement results (topmost ID 1 in FIG. 5) that include the desired determination results, which are displayed in the tolerance determination results list 34B that has been created, corresponding measurement results (Line-1 in FIG. 5) displayed on the captured image display screen 34A are provided with an emphasis display such as highlighting in step 180.

Accordingly, even in a case where a plurality of measurement results are displayed on one screen (FIG. 5 shows five in addition to ID1: ID2: Circle-1, ID3: Line-2, ID4: Distance-1, and ID5: Circle-2) and selection of the designated measurement results (here, ID1) within the captured image display screen 34A is difficult, by selecting measurement results that include the tolerance determination results that were converted into a list, the operator can easily discover the measurement position on the captured image display screen 34A corresponding to the measurement results in the list 34B and a mistaken selection of measurement results by the operator can be prevented from occurring.

In the present embodiment, the list 34B is configured by an individual determination results display region 34B 1 which provides details of the tolerance determination results for each measurement position; and an overall determination results display region 34B2 which provides overall determination results for the work piece 12 as a unit. In addition, the present embodiment is configured to display not only the individual determination results but also the overall determination results (“NG” in the drawings), and therefore the operator can discover the overall determination results extremely easily.

In the present embodiment, a number of NGs is also displayed in parentheses in the overall determination results display region 34B2, and therefore the operator can discover an extent of the NGs, as well.

Moreover, as in a first modification shown in FIG. 6, a total number of measurement results (five in this example) is set as a denominator and the number of NGs (two in this example) is shown as a numerator, enabling a ratio of the number of NGs to the total number of measurement results to be understood.

Furthermore, in the present embodiment, in addition to the captured image 34A from the camera 20 and the list 34B, a measured object overall view 34C showing the entire measured object is also displayed. Therefore, a position of the captured image (34A) relative to the entire measured object can be readily discovered. The measured object overall view 34C may also be omitted.

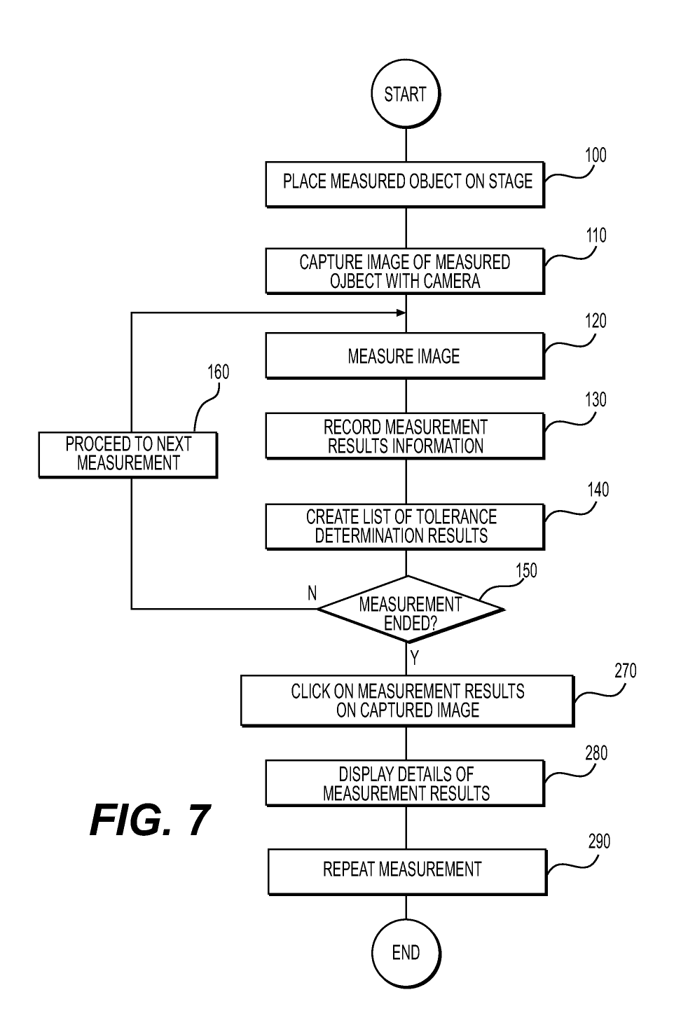

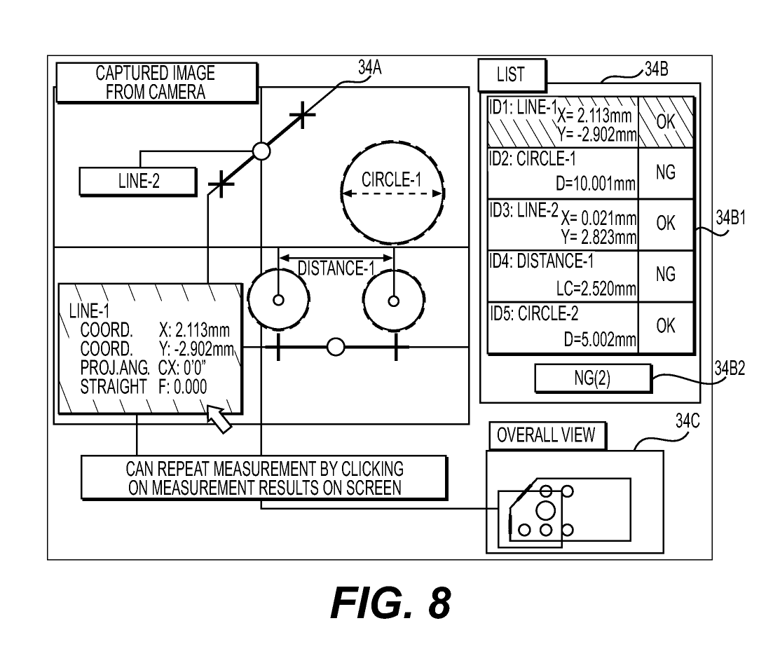

Next, a detailed description is given of a second embodiment of the present disclosure which facilitates remeasuring when selecting measurement results. A procedural flow according to the second embodiment is shown in FIG. 7, while an exemplary display on the display screen 34 is shown in FIG. 8.

After steps 100 to 150 are performed as in FIG. 4 and measurement ends, when the operator clicks on the measurement results (Line-1 in FIG. 8) displayed on the captured image display screen 34A in step 270, details of the measurement results (in this example, X and Y coordinates, projection angle, straightness) are displayed in step 280, as shown in FIG. 8. While the measurement results are displayed, measurement is repeated by clicking on the detailed display (step 290). When repeating the measurement, editing of a detection position of the detection tool used during measurement (re-entering design values that were manually entered when beginning measurement) is enabled, as well as editing of design values for the tolerance determination results and upper limit/lower limit values, making it possible to update the measurement results.

According to the present embodiment, measurement can be repeated simply by clicking on the measurement results displayed on the captured image display screen 34A, and work efficiency can be increased.

Moreover, instead of the measurement results displayed on the captured image display screen 34A, the operator can also select measurement results and determination results displayed in the individual determination results display region 34B1 of the list 34B and repeat measurement.

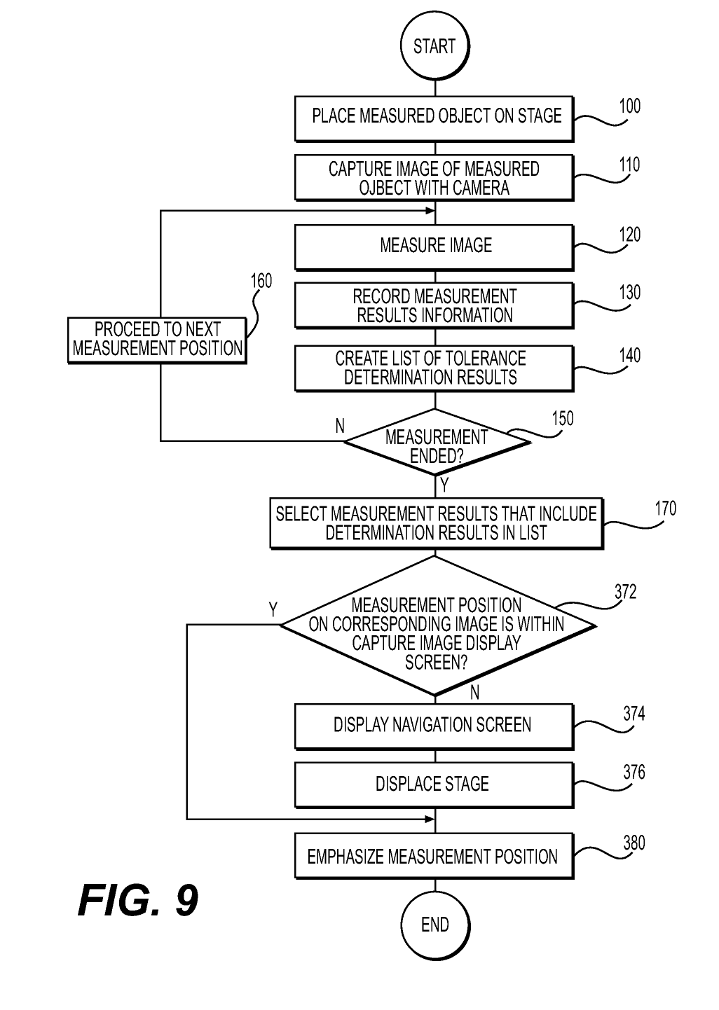

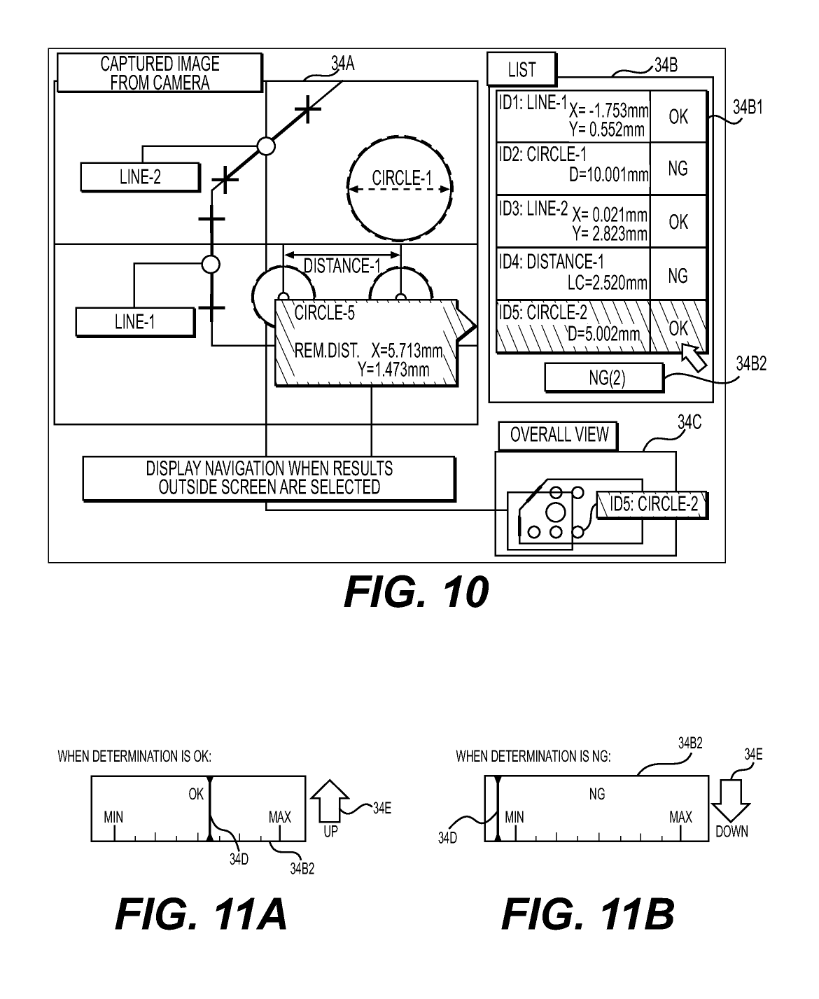

Next, a detailed description is provided for a third embodiment of the present disclosure, in which the measurement results and a stage position are linked, enabling stage displacement navigation in a case where the measurement position is not located in the captured image display screen 34A presently displayed. A procedural flow according to the third embodiment is shown in FIG. 9, while an exemplary display on the display screen 34 is shown in FIG. 10.

After the same step 170 as in the first embodiment ends, the process advances to step 372 and a determination is made as to whether the designated (selected) measurement results (ID5 in this example) are located within a present display screen of the captured image 34A. When the determination result is negative, the process advances to step 374 and a stage displacement navigation screen (here, an X axis direction and Y axis direction displacement distance toward ID5) is displayed on the screen, prompting stage displacement (step 376). Moreover, information for the remaining distance can be updated to align with the stage displacement.

The navigation is capable not only of displaying the remaining distance with a numerical value, as shown in FIG. 10, but is also able to present an intersection point of cross hair lines such that the intersection point displaces to be at the center of the captured image display screen 34A, for example, or to directly display a displacement direction with an arrow or the like. In addition, in the case of an automatically controlled image measuring device such as a CNC, the stage displacement of step 376 can be performed automatically.

When a determination is made in step 372 as to whether, due to the stage displacement because the designated (selected) measurement results were not displayed on the presently displayed screen in step 372, the designated (selected) measurement results are now displayed within the presently displayed screen or a determination is made that the designated (selected) measurement results are already displayed within the presently displayed screen, the process advances to step 380 and an emphasis display such as highlighting is placed on the measurement results displayed on the screen.

According to the present embodiment, by designating (selecting) measurement results that include the determination results on the list, navigation is performed for displacement toward the corresponding measurement position, and therefore work efficiency can be improved.

Moreover, in the present embodiment, the overall determination results are displayed in the overall determination results display region 34B2 using any of color differentiation, the letters “OK” and “NG” and the number of NGs. However, as in a second modification shown in FIGS. 11A (for OK) and 11B (for NG), a position of a measured value relative to a tolerance range of MIN to MAX can also be displayed within the overall determination results display region 34B2 in a meter shape, using an indicator needle 34D formed by a vertical line that moves left and right, as in the illustrated example. Thereby, the operator can intuitively understand details of the tolerance determination results, i.e., whether the measurement results approximate the design value or are on the edge of the tolerance range, whether the measurement results are larger or smaller than the design value, and the like.

Furthermore, the measurement results can also be displayed together with an arrow mark 34E indicating an increase/decrease direction of a value for the present measurement results relative to the previous measurement results. As a result, the operator can verify, in real time, a shift in the measurement results. In contrast, in a case where continuous measurement of work pieces having identical shapes is performed by a conventional image measuring system, in order to verify a shift in the measurement results, interpretation of each measurement result must be performed separately using a statistical/analytical function installed in the image measuring system or an external program having a statistical/analytical function, making it difficult for the operator to verify a shift in the measurement results in real time. Accordingly, the operator has difficulty verifying deviations and variations in the shape of a work piece. For example, even though a tool processing a work piece experiences wear and the like and processing accuracy of work pieces degrades over time, an operator performing measurement has difficulty noticing such degradation and is unable to detect the degradation until the tolerance determination results returned an “NG.”

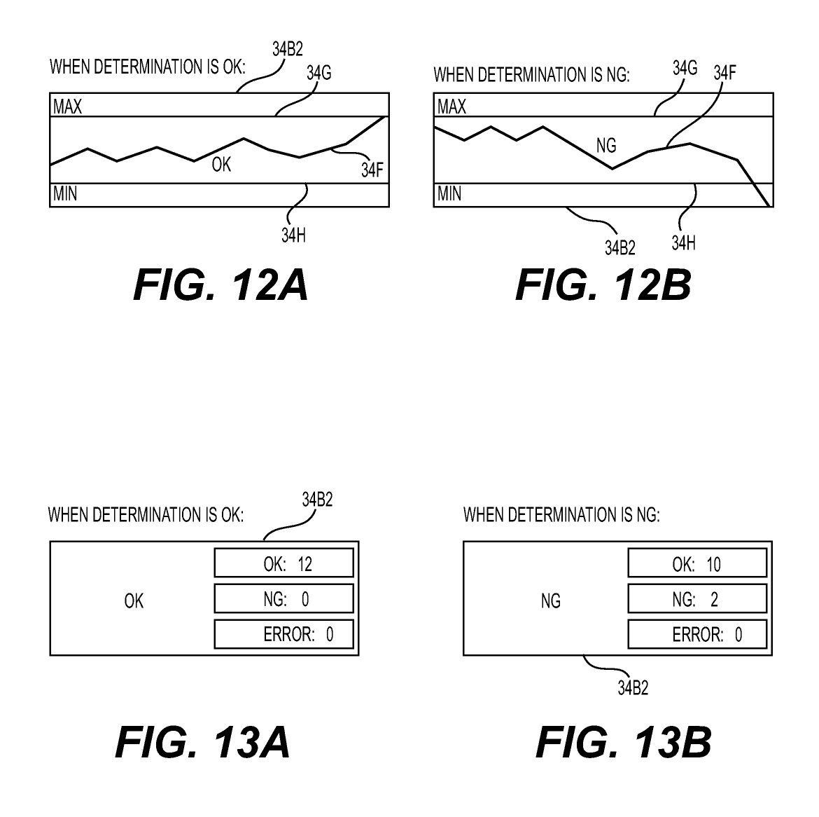

Alternatively, as in a third modification shown in FIGS. 12A (for OK) and 12B (for NG), a trend graph 34F illustrating shifts in the measurement results can also be displayed in the background of the overall determination results display region 34B2. In such a case, when displayed together with a maximum value MAX boundary 34G and a minimum value MIN boundary 34H, as shown in FIGS. 12A and 12B, the operator can readily grasp not only a trend, but also a relationship relative to an upper limit value and a lower limit value. The trend graph 34F may also be used alone.

In addition, as in a fourth modification shown in FIGS. 13A (for OK) and 13B (for NG), a number of OKs, a number of NGs, and a number of measurement errors can also be displayed together in the overall determination results display region 34B2. Moreover, in a case where the overall determination results return an OK only when all of the individual determination results are OK, a right side display may be omitted to enhance visibility in the case of an OK result, as shown in FIG. 13A. The error display may also be omitted. Moreover, in a case where the error may be ignored, displaying the number of errors is unnecessary.

In the above-described embodiment, tolerance determination results are displayed in the list 34B; however, the determination results displayed in the list are not limited to this. The display position of the list 34B is also not limited to that of the above-described embodiment, and the list 34B can instead be displayed in a corner of the captured image display screen 34A, for example.

The present invention is not limited to being applied to an image measuring device, and can also be applied to a quantitative microscope having an installed imaging unit, for example.

It is noted that the foregoing examples have been provided merely for the purpose of explanation and are in no way to be construed as limiting of the present invention. While the present invention has been described with reference to exemplary embodiments, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular structures, materials and embodiments, the present invention is not intended to be limited to the particulars disclosed herein; rather, the present invention extends to all functionally equivalent structures, methods and uses, such as are within the scope of the appended claims.

The present invention is not limited to the above described embodiments, and various variations and modifications may be possible without departing from the scope of the present invention.

What is claimed is:

1. An image measuring apparatus configured such that an image of a measured object placed on a stage is captured by a camera, the captured image is displayed on a captured image display screen, and determination results based on results of a measurement are displayed in an overview list separately from the captured image of the measured object, the image measuring apparatus comprising:
a selector configured to select measurement results that include determination results on the list; and
an emphasis displayer configured to provide an emphasis display on the captured image display screen for a measurement position corresponding to the selected measurement results.

2. The image measuring apparatus according to claim 1, wherein details of the measurement results are displayed at the measurement position having the emphasis display.

3. The image measuring apparatus according to claim 2, wherein measurement is repeatable while the details of the measurement results are displayed.

4. The image measuring apparatus according to claim 1, wherein, when the measurement position corresponding to the selected measurement results does not lie within the presently displayed captured image display screen, navigation information is displayed to cause the measurement position to be displayed within the captured image display screen.

5. The image measuring apparatus according to claim 1, wherein, when the measurement position corresponding to the selected measurement results does not lie within the presently displayed captured image display screen, the stage and the camera are displaced relative to each other to cause the measurement position to be displayed within the captured image display screen.

6. In an image measuring apparatus configured such that an image of a measured object placed on a stage is captured by a camera, the captured image is displayed on a captured image display screen, and determination results based on results of a measurement are displayed in an overview list separately from the captured image of the measured object, a method of displaying measurement results on the display screen of the image measuring apparatus, the method comprising:
selecting measurement results that include determination results on the list; and
providing an emphasis display on the captured image display screen for a measurement position corresponding to the selected measurement results.

7. The method according to claim 6, further comprising displaying details of the measurement results at the measurement position having the emphasis display.

8. The method according to claim 7, further comprising repeating the measurement while the details of the measurement results are displayed.

9. The method according to claim 6, further comprising, when the measurement position corresponding to the selected measurement results does not lie within the presently displayed captured image display screen, displaying navigation information to cause the measurement position to be displayed within the captured image display screen.

10. The method according to claim 6, further comprising, when the measurement position corresponding to the selected measurement results does not lie within the presently displayed captured image display screen, displacing the stage and the camera relative to each other to cause the measurement position to be displayed within the captured image display screen.
